(19) United States
(12) Patent Application Publication
(10) Pub. No.: US 2018/0338231 A1
(43) Pub. Date: Nov. 22, 2018

(54) METHOD AND SYSTEM FOR MANAGING TEMPORARY DETENTION OF CIVILIANS

(71) Applicant: Kevin M. Johnson, Natick, MA (US)

(72) Inventor: Kevin M. Johnson, Natick, MA (US)

(21) Appl. No.: 15/986,457

(22) Filed: May 22, 2018

Related U.S. Application Data
(60) Provisional application No. 62/603,268, filed on May 22, 2017.

(51) Int. Cl. H04W 4/46; G06K 9/00; H04W 4/14; G06F 17/30

(52) U.S. Cl. CPC H04W 4/46; G06K 9/00825; G06K 9/00288; G06K 2209/15; H04W 4/14; G06F 17/30864; G06K 9/00664

(57) ABSTRACT

A method includes receiving, at one or more processors, an identifier that is uniquely associated with a civilian vehicle, and accessing a registration database to determine one or more personal computing devices that are registered with the identifier. The method includes detecting that at least one of the one or more personal computing devices is located onboard the civilian vehicle, and generating an activation request signal for transmission to the at least one personal computing device onboard the civilian vehicle. Responsive to receiving an acceptance signal from a first personal computing device of the at least one personal computing device onboard the civilian vehicle, the method includes wirelessly communicating information to said first personal computing device.

### CROSS-REFERENCE TO RELATED APPLICATIONS

This application claims the benefit of U.S. Provisional Application No. 62/603,268, which was filed on May 22, 2017 and is titled System for Managing Communication Between Unacquainted Parties. The subject matter of which is herein incorporated by reference in its entirety.

### FIELD

Embodiments of the present disclosure generally relate to systems and method for managing the temporary detention of civilians by authorities, and more specifically to managing the interactions between civilians and authorities during temporary detentions.

### BACKGROUND

Violence resulting from authorities interacting with civilian motorists is a problem that has been revealed. The terms “authorities”, “officials”, and “officers” used herein refers to persons acting in a position of authority, and may include but are not limited to individuals representing law enforcement agencies (e.g., police, DEA, sheriffs, state troopers, FBI, housing, ICE . . . etc.), emergency response groups (fire, ambulance . . . etc.) or other governmental or private groups. The term “civilians” used herein refers to individuals who do not belong to these groups of persons that are in positions of authority. The problem of potential violence can exist between any authority member and any civilian, but mutual distrust and unnecessary confrontation between certain sub-groups of the civilian population and authorities can be particularly problematic.

There are many theories around why this problem exists and whether it has increased in frequency and magnitude, or, whether it has just become more known to the public as a result of social media and video tools embedded in mobile devices. In any event, it is clear that the problem does exist and it is not going away anytime soon.

One of the most problematic types of interactions takes place between an authority member and a motorist that the authority member has stopped (e.g., “pulled over”) for a temporary traffic stop or detention. Distrust and fear may be felt by both parties as they engage in a “blind” interaction—one where neither party has communicated nor beheld one another visually before they are literally and suddenly face to face. This is a dangerous type of situation, and with the proliferation of weapons, authorities have good reason for having feelings of anxiety and fear as they approach a vehicle with unknown occupants (e.g., a motorist driver and potential passengers). Because of the very nature of a traffic stop (which involves a face-to-face first interaction with no previous communication or visual assessment), an authority member may approach the vehicle with his/her hand on a gun to be cautious in case of a hostile occupant. This action, if perceived by occupants of the vehicle being approached by the unknown authority member, can exacerbate the fear and anxiety felt by the occupants. With fear, tension, and mistrust on both sides, the situation can be tense, and behaviors can be unpredictable and escalate quickly.

Authority members also face danger from other vehicles on the road during a traffic stop. For example, as an authority member exits his or her vehicle to approach the civilian vehicle, the authority member may be forced to walk along the side of a road that has active traffic, such as a highway. The authority member outside of the vehicle is exposed to a risk of getting hit by a passing vehicle.

It is recognized that interactions between authorities and civilians which start out in an ordinary manner can escalate very quickly, and sometimes with a violent conclusion. Any conversation that takes place between two individuals may begin in a friendly tone, but, given the “wrong” chemistry, language used, facial expressions, body posturing and/or tone of voice, it can quickly take a turn for the worse. In a situation where a law enforcement officer has pulled over a civilian motorist, there is an opportunity for this kind of escalation to occur. For example, during a traffic stop a law enforcement officer is approaching an unknown motorist with unknown occupants in the vehicle. The law enforcement officer is already in a compromised position by standing on the side of an active street or highway. If it is dark, the risk of danger is even higher. And, in this situation, the motorist civilian(s) inside the vehicle are being approached by an unknown person with a weapon (i.e. the law enforcement officer), and the motorist(s) are expected to follow the commands of the law enforcement officer. Both parties are tense and all it may take is a look of defiance by the motorist, or an unreasonable request by the law enforcement officer to ratchet up the situation. Other points of escalation can include the words used, the tone of voice, the volume, the lack of eye contact, too much eye contact, a movement to reach for something in the vehicle, or the like.

In addition to safety issues, this dynamic also touches a social nerve. Authorities have been accused of profiling, implicit bias, and/or outright prejudicial behavior. Law enforcement data shows that the rate of convictions of certain subgroups in the population is disproportionately high. As an example, if there are three subgroups in a population of individuals (subgroup “A”, subgroup “B”, and subgroup “C”), they may have different rates of criminal behavior and incarceration. For example the conviction rate of subgroup C for violent crime (normalized for the size of the population) may be two or three times the number of convictions for subgroup A. For specific crimes like murder, the conviction rate for subgroup C may be 6×-8× the rate of subgroup A. We know from behavioral scientists that humans, like animals, are subject to conditioning. So, if an experienced law enforcement agent lives and works in a world where individuals from subgroup C are 6-8× more likely to commit a murder as an individual from subgroup A, and almost 5× as likely to be incarcerated (see example table below), law enforcement agents may be more likely to treat individuals from subgroup C differently than individuals from subgroup A.

Example Incarceration Rates by Subgroup

| | | % of Incarcerated | Incarceration Rate | |
|---|---|---|---|---|
| Subgroup | % of Population | Population | per 100,000 | |
| Subgroup A | 60 | 40 | 450 | per 100,000 |
| Subgroup B | 25 | 20 | 800 | per 100,000 |
| Subgroup C | 15 | 40 | 2,500 | per 100,000 |

If the statistics reflect that an average individual from subgroup C is much more likely to commit a violent crime than an individual from subgroup A, and that, on average, the experience of law enforcement officials reflects these statistics, law enforcement agents are effectively “conditioned” to treat individuals from subgroup C with more caution and suspicion than individuals from subgroup A. In simple terms, law enforcement officials may have more reason to be wary of an average civilian/motorist from subgroup C than a civilian/motorist from subgroup A (with all other variables being the same).

In a perfect world, an innocent individual from subgroup C would be treated no differently than an innocent individual from subgroup A. However, until there is a shift in the data, and therefore, the experiences that shape the behavior of authorities, equal treatment will remain, on average, an unrealistic expectation.

It is not only learned behaviors that affect the way authorities treat different subgroups of civilians. All people have prejudices to some degree, and some people have deeply ingrained prejudicial beliefs that exist for reasons that run deeper than learned conditioning. And, of course, prejudice and prejudicial treatment is not limited to any one subgroup. There are individual characteristics that may cause people to treat others differently, such as race, gender, age (teenagers, seniors), religion, weight, or the like.

Even disregarding bias towards specific groups of civilians, when civilians are temporarily detained by authorities, it may be an inherently unpleasant experience for the civilians involved, potentially invoking stress, anxiety, fear, intimidation, embarrassment, or the like. For example, even subgroups of civilians that may be the least likely victims of bias may be anxious when approached by an officer during a traffic stop.

A need remains for enabling authorities to interact with civilians from all subgroups safely and fairly, providing an interaction that is as “blind” as possible with reduced opportunity for prejudicial treatment and escalation.

### SUMMARY

In one or more embodiments, a method is provided that includes receiving, at one or more processors, an identifier that is uniquely associated with a civilian vehicle, and accessing a registration database to determine one or more personal computing devices that are registered with the identifier. The method includes detecting that at least one of the one or more personal computing devices is located onboard the civilian vehicle, and generating an activation request signal for transmission to the at least one personal computing device onboard the civilian vehicle. Responsive to receiving an acceptance signal from a first personal computing device of the at least one personal computing device onboard the civilian vehicle, the method includes wirelessly communicating information to said first personal computing device.

In one or more embodiments, a system is provided that includes one or more processors and one or more data storage media operatively connected to the one or more processors. The one or more data storage media store a registration database and program instructions accessible by the one or more processors. Responsive to execution of the program instructions, the one or more processors are configured to access the registration database responsive to receiving an identifier that is uniquely associated with a civilian vehicle to determine one or more personal computing devices that are registered with the identifier. The one or more processors are configured to detect that at least one of the one or more personal computing devices is located proximate to an authority vehicle, and generate an activation request signal for transmission to the at least one personal computing device proximate to the authority vehicle. Responsive to receiving an acceptance signal from a first personal computing device of the at least one personal computing device proximate to the authority vehicle, the one or more processors are configured to wirelessly communicate with said first personal computing device.

In one or more embodiments, a non-transitory computer-readable storage medium is provided that has computer executable code to access a registration database in response to receiving a vehicle identifier that is uniquely associated with a civilian vehicle. The registration database is accessed to determine one or more personal computing devices that are registered with the civilian vehicle in the registration database based on the vehicle identifier. The computer-readable storage medium has computer executable code to detect that at least one of the one or more personal computing devices is located onboard the civilian vehicle based on a proximity of the at least one personal computing device to a location of an authority vehicle that is proximate to the civilian vehicle, and to generate an activation request signal for transmission to the at least one personal computing device onboard the civilian vehicle. Responsive to receiving an acceptance signal from a first personal computing device of the at least one personal computing device onboard the civilian vehicle, the computer executable code is configured to wirelessly communicate information to said first personal computing device.

In one or more embodiments, a method is provided that includes receiving, at one or more processors, an initiation signal from a first personal computing device, and determining a location of the first personal computing device. The method includes detecting an authority member that is proximate to the first personal computing device based on the location of the first personal computing device, and generating an activation request signal for transmission to an authority computing device associated with the authority member. Responsive to receiving an acceptance signal from the authority computing device, the method includes wirelessly communicating information between said authority computing device and said first personal computing device.

### BRIEF DESCRIPTION OF THE DRAWINGS

FIG. 1 is a flow chart of a method for managing the interactions between civilian motorists and authorities during a traffic stop according to an embodiment.

FIG. 2 is a block diagram illustrating a mediation system formed in accordance with one or more embodiments.

FIG. 3 is a flow chart of a method for managing the interactions between civilian motorists and authorities during a traffic stop according to an embodiment.

FIG. 4 illustrates a traffic stop in which a patrol vehicle has pulled over a civilian vehicle on the side of a road according to an embodiment.

FIG. 5 illustrates a personal computing device onboard a detained vehicle according to an embodiment.

### DETAILED DESCRIPTION

The embodiments described herein address the needs described above. For example, one or more embodiments described herein provide a system and method for increasing safety and mitigating violence between authorities and the civilians with whom they interact during a temporary detention. The system may in essence serve as a mediator and communication manager between two “unacquainted” parties, the authority member and the civilian that is temporarily detained. The system and method also include thoroughly tracking and recording the communications between the authorities and civilians during such interactions. For authorities, the system and method described herein provide the advantages of increasing safety and reducing potential liability. For civilians, the system and method can reduce, and potentially eliminate, the influence of bias, and can result in less fear, anxiety, intimidation, and/or risk of violence experienced during a temporary detention. The inventive subject matter described here is comprehensive, but it is understood that the system and method have value even if only followed in part.

Although one or more embodiments described herein are directed to the situational interaction between authority members (e.g., law enforcement officers) and civilian motorists during traffic stops, the inventive subject matter is not so limited to traffic stops involving vehicles and can also be applied to other types of interactions between civilians and authorities. For example, some other potential applications of the inventive subject matter described herein may include situations in which authority members visit buildings. For example, the system and method described herein, or at least portions thereof, can be applied to increase safety and reduce the influence of prejudice when law enforcement personnel visits a building, such as a dwelling (e.g., house, apartment, or the like), for a home visit, to investigate suspicious activity, to execute a search warrant, to execute an arrest warrant on a civilian within the building, or the like.

Certain embodiments described herein provide a mechanism for enabling remote communications between an authority member and a civilian occupant within a vehicle or a building prior to (or instead of) the two parties meeting face-to-face. By establishing a line of communication, the authority member can set expectations and the civilian can convey special notifications or requests before the face-to-face engagement, thereby reducing uncertainty and tension during the upcoming engagement.

At least one technical effect of some embodiments includes increasing the safety of authority members by reducing the amount of time that an authority member is outside of his or her vehicle and exposed to active traffic during a traffic stop. Another technical effect is reduced threat of violence between the authority member and the civilian occupant(s) in the vehicle because a line of communication is established and expectations are set prior to a face-to-face engagement. Still another technical effect is a reduced influence of prejudice on the interaction and the outcome of the interaction because some personal identifying information about the civilian occupants may be withheld from the authority member until and unless such personal information is determined to be relevant for safety reasons. For example, the system and method may be configured to verify the identity of the civilian driver without conveying personal information about the driver, such as name, age, gender, etc., to the authority member. Yet another technical effect of the embodiments is a reduction in uncertainty and speculation about the facts of the interaction between the two parties during the temporary detention by automatically recording the communications (e.g., text-based, voice-based, video, etc.) between the two parties on a data storage medium. The automated recording of the interaction may be useful for examining potential liability resulting from the temporary detention.

The following describes a system and method for managing communications or “mediating” interactions between authorities and civilians during temporary detentions, and the system may be referred to herein as a mediation system. The mediation system may implement a novel combination of software, servers, technologies and processes. The description below is largely focused on authority-civilian interactions when vehicles are involved (e.g. a traffic stop), but as mentioned previously, the system has applicability in other instances as well.

Before authorities and civilians interact and meet face-to-face, there are advantages of establishing communication between the two parties. In certain situations, the two parties may never need to meet face-to-face to accomplish a successful outcome. For instance, in the case of a routine traffic stop for a minor traffic infraction, the mediation system and method described herein may enable a civilian to receive a warning or a ticket (e.g., citation) without having a face-to-face interaction with an authority member (e.g., law enforcement officer), as the authority member may be able to remain in his or her vehicle. It is important to note, however, that the embodiments described herein do not restrict or prevent an authority member from resorting to more traditional methods of handling temporary detentions, such as approaching vehicles and interacting with civilian occupants via the driver window or the passenger window. Even if the authority member decides to approach the civilian vehicle for a traditional face-to-face-interaction, the mediation system and method described herein may enable communications between the parties prior to the authority member exiting his or her vehicle, and both parties may benefit from the information conveyed using the mediation system and method prior to that point.

As used herein, an element or step recited in the singular and proceeded with the word “a” or “an” should be understood as not excluding plural of said elements or steps, unless such exclusion is explicitly stated. Furthermore, references to “one embodiment” are not intended to be interpreted as excluding the existence of additional embodiments that also incorporate the recited features. Moreover, unless explicitly stated to the contrary, embodiments that “comprise,” “have,” or “include” an element or a plurality of elements that have a particular property may also include additional such elements that do not have that particular property. Furthermore, when an element is described as being based on a factor or parameter, the term “based on” should not be interpreted as the factor or parameter being the sole factor or parameter, but may include the possibility that the element is also based on other factors or parameters.

The following detailed description of certain embodiments will be better understood when read in conjunction with the appended drawings. To the extent that the figures illustrate diagrams of the functional blocks of various embodiments, the functional blocks are not necessarily indicative of the division between hardware circuitry. For example, one or more of the functional blocks (e.g., modules, processors, or memories) may be implemented in a single piece of hardware (e.g., a general purpose signal processor or random access memory, hard disk, or the like). Similarly, programs may be stand-alone programs, may be incorporated as subroutines in an operating system, may be functions in an installed software package, may be a software surface package that is run from a computer server remotely, or the like. It should be understood that the various embodiments are not limited to the arrangements and instrumentality shown in the drawings.

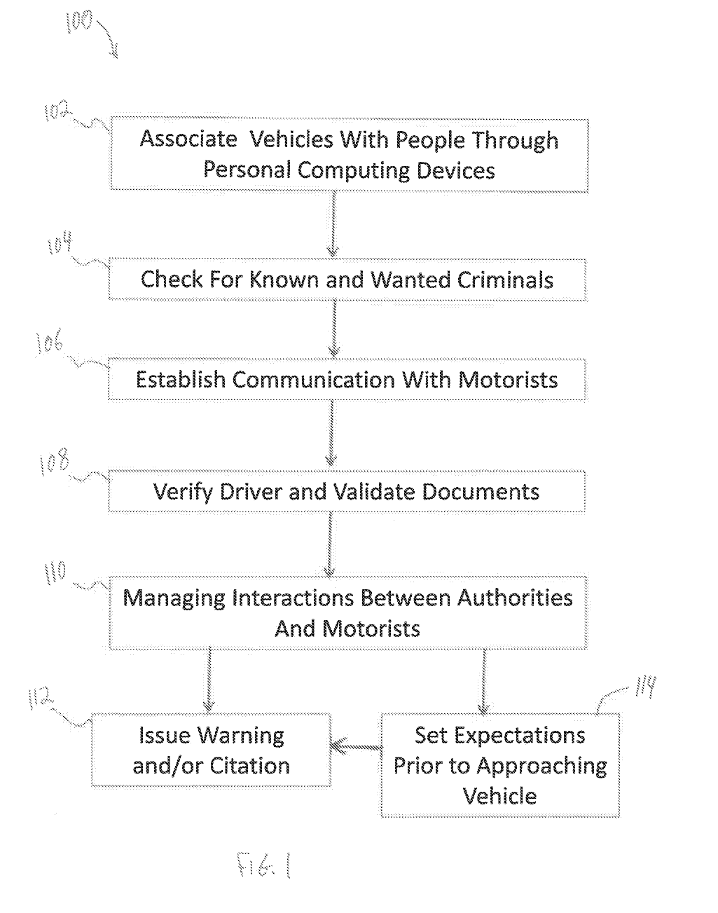

FIG. 1 is a flow chart of a method 100 for managing the interactions between civilian motorists and authorities during a traffic stop according to an embodiment. The method 100, or at least portions thereof, may be performed via a mediation system that includes one or more processors. The mediation system may include or represent a mobile or web-based application that utilizes processors in a remote server.

At 102, vehicles are associated with people (e.g., individual civilians) through personal computing devices in a registration or enrollment process. For example, by registering a personal computing device, such as a mobile phone or tablet computer, to a specific vehicle, the person that owns the personal computing device is associated with the vehicle. Once one or more personal computing devices are registered with a given vehicle, when that vehicle is pulled over by an authority vehicle during a traffic stop, the mediation system is configured to manage communications between the occupant(s) in the stopped vehicle and the authority member(s) in the authority vehicle.

The first step of the registration process may involve a civilian logging into a webpage or mobile application associated with the mediation system. The civilian may input information about their vehicle (e.g., the license plate number, vehicle identification number (VIN), and/or the like) into the mediation system software, as well as personal information (e.g., the civilian's name) and contact information (e.g., a phone number) for the civilian's personal computing device. Each vehicle may be associated with one or more civilians, as some people may share vehicles within family units or the like. Likewise, a single civilian may register to be associated with multiple vehicles that are owned or periodically driven by that civilian. The registration process can be done on-line, or via a mobile device to which an application for the mediation system has been downloaded. The application of the mediation system is referred to herein as “the Mediation App”. Optionally, during the registration process the civilian may be prompted to provide additional information besides a cell phone number, such as a personal photo depicting the civilian's face, a photo depicting the civilian's driver's license, and other personal information about the civilian such as name, address, contact references, or the like. The information input by the civilian during the registration process is stored in a registration database that is accessible by a remote server, as described herein.

It is noted that the mediation system may have multiple versions of the Mediation App. For example, a first version of the Mediation App may be utilized by civilians, and a second version of the Mediation App may be utilized by authorities. The different versions may have different user interfaces, provide different information, or the like. The different versions may be connected to one or more remote servers via a network.

When a vehicle with one or more civilians is stopped by an authority member, such as a law enforcement officer, the authority member can selectively activate the authority version of the Mediation App from his/her laptop or mobile device. The Mediation App can also be automatically launched based on other conditions. For example, the authority member switching on lights and/or sirens may transmit an electrical activation signal to the laptop and/or mobile device that automatically activates and open the Mediation App. The Mediation App may prompt the authority member to enter an identifier into the Mediation App. The identifier may be uniquely associated with the specific vehicle or building occupied by the civilians. For example, if the civilians are within a vehicle, the identifier may be the license plate number, the VIN, or the like, of the civilian vehicle that is stopped. Alternatively, if the civilians are within a building, the identifier may be an address of the building, a name of the building, or the like. The identifier is referred to herein as “vehicle identifier” because the illustrated embodiments describe a traffic stop. In an alternative embodiment, instead of inputting the vehicle identifier into the Mediation App, the authority member may communicate the vehicle identifier verbally to a person in another location that has access to the Mediation App, such as a person in a dispatch center. It should be understood that any and all the functions of the Mediation App could be integrated into other software and/or hardware, and is not limited to the software and hardware described herein.

In an alternative embodiment, instead of the authority member inputting the vehicle identifier into the Mediation App or communicating the vehicle identifier, the Mediation App may automatically receive the vehicle identifier through another means. For example, the authority member may enter the vehicle identifier into another software program, which is configured to automatically feed the identifier to the Mediation App. Another example may be that the vehicle identifier is automatically read by one or more devices or equipment available to the authority, which automatically feeds the identifier to the Mediation App. In a non-limiting example, the vehicle identifier may be stored or embedded on a radio frequency identification (RFID) tag, or other data-storing technology, that is mounted on the civilian vehicle. The authority may have an RFID reader or another type of sensor onboard the authority vehicle that is able to interrogate the RFID tag to extract the vehicle identifier and upload the vehicle identifier to the Mediation App. The same or a similar type of technology could be used to indicate that a particular vehicle has registered users associated with it. For instance, the RFID tag could directly communicate that the civilian vehicle is registered with the Mediation App. In another example, the authority vehicle may include a camera or optical sensor that is configured to obtain image data of the license plate (or other identifier), and perform automated image analysis to determine the license plate number.

Once the identifying information from the vehicle (e.g. license plate number, VIN, or the like) is entered into the Mediation App on the authority's computing device, the software connects with a Mediation App remote server (cloud or other) that contains the registration database of registered users. One or more processors of the remote server may use the vehicle identifier to search in the registration database for personal computing devices that are associated or registered with the civilian vehicle that is stopped. The personal computing devices may be cell phones, but also could include tablet computers, laptop computers, digital cameras, video game consoles, personal digital assistant devices, or the like that have the hardware and software to enable the communications described herein.

Once the personal computing devices associated with the particular civilian vehicle are identified, the remote server (e.g., one or more processors thereof) reaches out to these devices through a notification service. If there is more than one personal computing device associated with the vehicle in the registration database, then a notification message may be transmitted to each of the associated personal computing devices. The notification message may include an activation request, which prompts the personal computing device to establish a communication link that allows for communications to be transmitted between the personal computing device and the remote server via a network. For example, the communication link may have certain protocols or rules for communications and by responding to the activation request the personal computing device may acknowledge the protocol.

In one or more embodiments, the mediation system may be configured to determine which of the personal computing devices registered to the vehicle are currently onboard the vehicle (e.g., currently physically located within or on the vehicle), and may transmit the notification with the activation request to only the one or more personal computing devices that are onboard. The mediation system may be configured to determine which of the personal computing devices are onboard the vehicle based on a determined proximity of the registered personal computing devices to the authority vehicle that has stopped the civilian vehicle. For example, the Mediation App of an authority computing device associated with an authority member or authority vehicle may transmit location data of the authority computing device to the remote server. The location data may represent global positioning system (GPS) coordinates, or the like. The remote server may utilize location-based services (e.g. GPS) on the personal computing devices to receive location data corresponding to the personal computing devices, and may compare the locations of the personal computing devices to the location of the authority vehicle to determine which of the registered personal computing devices, if any, are within a designated proximity of the authority vehicle indicating that the client computing devise are most likely onboard the civilian vehicle that is stopped. For example, the designated proximity may be 50 meters (m), 40 m, 20 m, or the like. If the location data indicates that only a first registered personal computing device is within the designated proximity to the location of the authority vehicle, then the remote server of the mediation system may only transmit the notification message with the activation request to the first personal computing device. Besides GPS, additional information about the locations of the personal computing devices can be used to refine the match with the vehicle, including current and historical speed and direction, or whether it is stationary.

In an alternative embodiment, the remote server may receive location data from the personal computing devices as well as from a location-determining device secured onboard the civilian vehicle. For example, the civilian vehicle may have a GPS device integrated or mounted within the civilian vehicle, which may be configured to transmit location data of the civilian vehicle to the remote server. The remote server may compare the location data received from the personal computing devices to the location data of the civilian vehicle to determine which, if any, of the personal computing devices are in the same location as the civilian vehicle, indicating that those personal computing devices are onboard the civilian vehicle.

The location-based services of the registered personal computing devices may be accessed if the location-based services are enabled in the settings of the Mediation App on the personal computing devices. For example, a law enforcement officer can initiate a search for all enabled phones that have a location that is within a designated proximity range of the law enforcement vehicle's location. Alternatively, the remote server may be able to “ping” the registered personal computing devices to determine current locations of the personal computing devices. In one alternative embodiment, instead of using GPS, the authority vehicle (or a device therein) may establish a local network, such as a W-Fi hotspot, and may attempt to connect with the registered personal computing devices on the local network. The local network may have a limited range (e.g., 50 m or the like), such that if any of the registered personal computing devices connect to the local network, there is a strong likelihood that those personal computing devices are onboard the civilian vehicle that is stopped. In another alternative embodiment, the authority vehicle (or a device therein) may attempt to connect to the registered personal computing devices associated with the civilian vehicle via Bluetooth® or a similar connection protocol that has a limited range (e.g., 20 m, 10 m, or the like). If any of the registered personal computing devices connect to the authority vehicle, then there is a strong likelihood that those personal computing devices are onboard the civilian vehicle that is stopped.

In one or more embodiments, the mediation system may alert and notify persons that are not within the civilian vehicle that is stopped to inform those persons as to the occurrence of the stop. For example, the mediation system may transmit notification messages to personal computing devices that are registered with the vehicle but determined, based on proximity, to be outside of the civilian vehicle during the stop. For example, if the location data provided by one registered cell phone is a mile from the location of the authority vehicle that has pulled over the civilian vehicle and is parked behind the civilian vehicle, then the mediation system concludes that the cell phone is not within the civilian vehicle at the present time. The mediation system may transmit a notification message to that cell phone to inform the user (e.g., owner or possessor) of the phone that the civilian vehicle has been pulled over by an authority for a driving infraction. Optionally, during the registration process, a user may be prompted to provide contact information of persons that are to be contacted in the event of a traffic stop. For example, the user can set preferences during registration about which personal computing devices are to receive notifications. The user may also select the means of communication during the registration process, such as text, email, phone call, etc. In a non-limiting example, a user may select as contact persons the parents or guardians of a teenager or young adult that is a registered driver of the vehicle. Upon accessing the registration database based on the vehicle identifier, the remote server may generate and transmit a notification message to the contact persons that are listed in the registration database.

In addition to notifying third parties that the civilian vehicle has been pulled over by the authority, the remote server of the mediation system may also be configured to transmit additional messages to the third parties to convey copies of all, or at least some, of the subsequent communications that takes place between the authority member and the occupants of the vehicle during the traffic stop. For example, a father may be provided with the communications between his son and a law enforcement officer, and track the interaction in almost “real-time” during the stop. The timely notification can allow the father (or other third party) to separately contact and communicate with the son within the vehicle, providing reassurance to the son and explaining how to behave for the authority member to reduce the risk of an escalated confrontation.

In one or more embodiments, personal information and characteristics of the civilian occupants of the vehicle are not provided to the authority member that stopped the civilian vehicle. For example, identifying information, such as name, age, ethnicity, gender, appearance, or the like, that may have been entered at the time of the user's registration is not communicated to the authority member during the traffic stop. In at least one embodiment, the information provided to the authority member during the traffic stop is limited to whether and how many occupants in the vehicle are registered with the mediation system. The mediation system establishes the first steps of a process for a “blind” interaction between the authority member and the civilian occupant(s). Each jurisdiction (e.g. state, municipality, etc.) may require that certain types of information are divulged to the authority member, and the mediation system may be configured to comply with jurisdictional rules and regulations. It is noted however, that the mediation system may provide the authority member with information about the occupants if such information is likely to assist in the interaction, such as if any of the occupants have a physical disability. For example, it may be useful for an authority member to know that an occupant does not speak English, has a hearing impairment, has a medical condition, or has another condition, like autism. By divulging limited personal information that is relevant to the interaction, the authority member may be less surprised, confused, or fearful during the interaction with the occupants.

At 104, a check is performed for known and wanted criminals. This is a traditional practice that is performed during traffic stops. The authority member verifies that the civilian vehicle pulled over is not registered to a wanted criminal (e.g., with active warrants for arrest) or someone with a serious criminal record, and also whether the vehicle has been classified as stolen. Currently, this check is done when the license plate is entered into an existing software system (or called in to a dispatch center. The system then checks a database to determine to whom the vehicle is registered and whether there is criminal offender associated with the vehicle.

Optionally, this check may be performed using the Mediation App instead of, or in addition to, the current channels. For example, the Mediation App may connect to the state and/or federal criminal records databases. In at least one embodiment, if the vehicle and registered owner check out as negative, meaning that the vehicle is not listed as stolen and the registered owner is neither wanted for arrest nor a convicted felon, then the Mediation App notifies the authority member of these facts without divulging personal information about the registered owner to the authority member. For example, the Mediation App withholds information about the registered owner's name, age, gender, race, etc. from the authority member, which may be different than the conventional procedure. Alternatively, if the registered owner is determined to be a wanted criminal or a convicted felon and/or if the vehicle is stolen, then the Mediation App may provide personal information about the registered owner to the authority member. In such a situation, the traffic stop is no longer a routine stop, and the safety of the authority member outweighs the potential risk of bias in the interaction.

If the search is negative (no criminal, no stolen vehicle, etc.), the mediation system enables the authority member to complete the rest of the traffic stop without the authority member exiting his or her vehicle. For example, the authority member is able to communicate indirectly with the civilian occupant of stopped vehicle using the Mediation App to discuss the reason for the traffic stop and even to issue any warning or citation. It is noted, however, that the mediation system does not in any way interfere or restrict the authority member from choosing to break from the procedure of the mediation system at any time to proceed according to traditional methods. For example, the authority member may utilize the mediation system until the authority member observes suspicious activity within the civilian vehicle. Upon witnessing suspicious activity, the authority member may opt for the traditional method of exiting the vehicle and approaching the civilian vehicle. The mediation software may provide a means for the authority member to document why he or she chose to abandon the mediation procedure and proceed with more traditional means. Even if the authority member ultimately makes the decision to pursue a more traditional traffic stop, the mediation procedure steps that were performed and completed prior to pursuing the traditional traffic stop may still mitigate confrontation and escalation, as described herein. To summarize, the mediation system and method described herein does not obstruct or interfere with the current process of checking for known or wanted criminals, and can work in conjunction with or adjacent to that process.

At 106, communication is established between the mediation system and the civilian motorists (e.g., occupants) within the civilian vehicle that is stopped. The communication may be established subsequent to identifying the personal computing devices (e.g., cell phones) associated with the civilian vehicle and alerting the authority member whether and how many registered users are in the vehicle (e.g., based on the number of registered personal computing devices within the vehicle). In at least one embodiment, the authority member initiates communication to the registered user(s) in the vehicle via the Mediation App on the authority member's computing device (e.g., computer or laptop). The authority member may “initiate communication” by making a selection on the user interface of the Mediation App in the computing device indicating that the authority member wishes to communicate to the civilian occupant(s). In response, the computing device onboard (or associated with) the authority vehicle wirelessly transmits a signal to the remote server.

The remote server, in response, proactively sends an activation request signal to the personal computing devices that are determined to be within the civilian vehicle. The activation request signal may represent a push notification that prompts the user of the personal computing device to activate the Mediation App on the personal computing device to establish a communication link or channel. Alternatively, the activation request signal may automatically activate the Mediation App on the personal computing device upon receipt by the personal computing device. The activation request signal may provide information about the communication link or channel, such as identifying a specific protocol or language that is used for subsequent communications. The personal computing device may transmit a response signal to the remote server to acknowledge the receipt of the activation request and confirm the protocol and other rules for communications, thereby establishing a communication link between the personal computing device and the remote server.

In an alternative embodiment, the authority member may initiate the communication with the personal computing devices in the civilian vehicle by the authority vehicle transmitting or broadcasting a signal to the personal computing devices, through a local network (e.g., Wi-Fi or equivalent), a Bluetooth connection, or the like. The personal computing devices within the civilian vehicle may be configured to activate the Mediation App and establish a communication link (e.g., wireless connection) with the remote server upon detecting the signal communicated by the authority vehicle. In another alternative embodiment, one or more of the occupants in the civilian vehicle may initiate communication with the remote server instead of the authority. For example, upon being pulled over, a registered user may activate the Mediation App on their personal computing device or may dial a designated number that is affiliated with the mediation system, such as “611”. The remote server may utilize location-based services or the like to match the personal computing device that activated the Mediation App (or dialed the designed number) with the specific authority vehicle that pulled over the civilian vehicle.

In at least one embodiment, subsequent communications take place through the Mediation App, and are recorded in a database connected to the remote server. This same information can also be stored on either or both of the computing devices of the authority member and the civilian occupant(s). It is noted that the mediation system allows the authority member inside the authority vehicle to communicate indirectly with the occupant(s) inside the civilian vehicle that is stopped by the authority vehicle via the remote server. For example, a request for information submitted by the authority member is transmitted as a first signal to the remote server via the Mediation App, which processes the request and generates a second signal that is transmitted to one or more recipient personal computing device(s) onboard the civilian vehicle and displayed using the Mediation App. The second signal is based on the first signal, but may have different content than the first signal. Likewise, communications between the personal computing devices and the remote server may be filtered and/or modified before being transmitted from the remote server to the authority member, such as to remove personal information about the occupant(s) from the information that is provided to the authority member. Therefore, in at least one embodiment, the computing device of the authority member does not communicate directly with the personal computing devices within the civilian vehicle. It is recognized that the references to “remote server” herein may include one or more remote servers. For example, the remote server may be the remote server 130 shown in FIG. 2, which may represent only one server or a plurality of servers that are operably connected to each other.

At 108, the driver of the civilian vehicle is verified and driver-related documents are validated. As part of the conventional or traditional traffic stop process, the authority member will typically exit the authority vehicle and approach the motorist vehicle to request the motorist driver to provide the driver's license and vehicle registration. During this period, the authority member may also visually evaluate any “inspection” sticker on the vehicle to determine when the state inspection of the vehicle expires. The authority member may also peer through one or more windows of the vehicle to look for any suspicious persons or items in the passenger compartment of the vehicle. In one or more embodiments, the mediation system is configured to perform of sequence of actions to verify the driver of the motorist vehicle and validate driver-related documents without requiring the authority member to exit the authority vehicle or approach the motorist vehicle. As described in more detail herein, the mediation system prompts the occupant(s) of the vehicle, through the Mediation App on one or more of the personal computing devices to obtain image data to various subjects. The subjects may include the occupant's own face for identification and verification of identity, the occupant's driver's license, the vehicle registration document, the inspection sticker, and/or the like. The image data that is captured upon request by the Mediation App is transmitted from the personal computing device to the remote server. One or more processors of the remote server may process the image data to verify the identity of the driver, confirm that the purported driver is currently sitting in the driver's seat, validate the driver's license, vehicle registration, and/or inspection status, or the like.

The authority member may initiate the verification and validation process by utilizing the Mediation App on the authority computing device (e.g., a mobile device or a device integrated into the authority vehicle) to transmit a request signal to the remote server to begin the sequence. The remote server in response may transmit an activation request signal to the personal computing device(s) onboard the civilian vehicle. If a first occupant accepts the request by via the Mediation App on the personal computing device possessed by the first occupant, the remote server (via the Mediation App) instructs the driver through a step-by-step sequence to obtain image data of the various specified target subjects. The image data may be still images or video.

In an example step, the Mediation App may instruct the person in possession of the registered personal computing device to obtain image data depicting the person's own face and head as well as the person's driver's license. In an embodiment, the Mediation App accesses the camera feature of the computing device without exiting the Mediation App. The Mediation App may require the person to obtain the requested image data in real time in response to receiving the prompt, and may prevent the person from uploading or selecting image data acquired previously and already stored on the personal computing device, thereby securing a chain of custody of the image data. For example, the motorist possessing the personal computing device is not able to upload an image of a person who is not in the vehicle when prompted to obtain a self-image (e.g., selfie) or otherwise tamper with the image data in an attempt to conceal the motorist's true identity. Upon capturing the requested image data, the personal computing device may send the image data to the remote server.

The mediation system may use image processing (e.g., face recognition) algorithms and software to compare the self-image of the motorist's face with a reference image of a known person. For example, the reference image may be the image that is on the driver's license. The image data depicting the motorist's face may be compared to the image data of the person on the driver's license to determine whether the people in the two images are the same person. Other image processing algorithms, such as optical character recognition (OCR), may be used to extract the text from the driver's license. The name on the driver's license may be compared to names on file in the registration database that are associated with the motorist vehicle and the specific personal computing device that captured the image data. In one non-limiting example, the image data depicting the state issued driver's license and the image data depicting the motorist's own face (e.g., selfie) are compared using COTS facial recognition software (called one to one (1:1) FRS). A positive match between the compared images and the compared names establishes that the citizen is a valid and registered driver with the state, and that there is no fraud in his or her identity. Note that instead of a single still photo, the validation may take place through sequential photos or a video for the facial identification and validation.

In another embodiment, the reference image against which the motorist selfie image data is compared for facial recognition may be an image that is stored in a database instead of or in addition to the driver's license, and associated with a known person. The selfie image is therefore compared to the stored image and not to the driver's license. For example, the motorist may be prompted to acquire or upload an image showing the motorist's face as part of the registration process with the mediation system, and this image may be used as the reference image. The image may be stored in a federal or state database. It is noted that the face recognition software could be stored on the motorist's personal computing device, the authority member's computing device, or the remote server. For example, the mediation system may utilize the remote server to perform the image analysis between the selfie image data and the reference image. Alternatively, the remote server may transmit the selfie image data to the authority member's personal computing device or the motorist's computing device to perform the image analysis, and the results of whether or not there is a positive match may be transmitted back to the remote server.

As an alternative to utilizing image processing algorithms and techniques, the Mediation App may transmit the selfie image of the motorist and the reference image to a remote person (e.g. a dispatcher) who can manually visually compare the two images to determine whether or not the subjects match. For example, the remote person may compare the selfie taken by the motorist to the photo on the driver's license to validate that the motorist is, in fact, the person named on the driver's license and/or in the registration database.

It is recognized that during this verification and validation process to determine the identity of the motorist, the mediation system may be configured to withhold the personal information of the motorist, including the images showing the motorist, from the authority member that pulled over the vehicle. Withholding such personal information may reduce the influence of bias affecting the interaction. For example, upon verifying the identity of the motorist, the Mediation App may notify the authority member only that a positive identification has been made, without providing any personal information about the motorist to the authority member.

The image data depicting the driver's license held by the motorist may be communicated to the remote server to validate the driver's license. For example, OCR software or other image processing techniques may be used by one or more processors at the remote server to extract textual data from the driver's license. The one or more processors may access a database to confirm that the license is valid by comparing the text in the fields on the driver's license with text in the database. Because different states may have information stored in different areas on the licenses, the OCR software can be programmed to know “where to look” on the images for specific types of information.

Similar to the driver's license, the authority member may utilize the Mediation App to request that the motorist acquire image data depicting the vehicle registration document, an inspection status sticker, and/or other relevant documents. The Mediation App may prompt the motorist to acquire such images one at a time and the image data may be transmitted remotely to the remote server for analysis. For example, the remote server may use OCR to extract textual information from the images. The image analysis may be able to flip the image data depicting the inspection sticker if the sticker faces outward and the image is acquired from within the vehicle. The remote server may compare the information obtained to a database to verify that the vehicle is properly registered and the inspection status is not expired. It is noted that these actions may occur while the authority member remains in the authority vehicle.

Again, in a more manual mode, the image data of the driver's license, registration, inspection sticker, etc., could be sent to the authority member or a person in a remote location, who could then access a database to confirm that the documents are valid and up-to-date, instead of using automated processing.

In at least one embodiment, the mediation system does not present the personal information of the motorist, such as the driver's license, registration, inspection sticker, etc. to the authority member that stopped the civilian vehicle. The mediation system may provide status updates to the authority member, such as whether or not the motorist's driver's license, registration, etc. have been validated.

In an alternative embodiment, the mediation system may be configured such that some or all of the image data acquired via the motorist's personal computing device using the Mediation App may be communicated from the remote server to the authority member in the authority vehicle instead of withholding the personal information from the authority member. While this scenario is not a “blind” process, it can still allow the authority member to conduct the traffic stop remotely and improve the safety for both the motorists and the authority member.

As an alternative to the above processes, when registering for the Mediation Service initially, a user can upload his or her driver's license, a selfie, and other pertinent information so that the user can be “pre-approved” as a legitimate driver with a legitimate driver's license. During the registration process the user's identity can be validated by comparing the submitted selfie against a reference image of the user, such as the photo on the driver's license or a photo in a separate database (e.g., a federal or state database). In this manner, the motorist can be “pre-approved” (akin to the “Precheck” program of the Transportation Security Administration (TSA)). The pre-approval process may save time and reduce the number of validation steps during a subsequent traffic stop in which the pre-approved motorist is pulled over. The comparison of the newly-acquired selfie image to a validated image of the purported motorist uploaded during the pre-approval registration process reduces the ability of a motorist to fraudulently pose as a passenger in the vehicle during the traffic stop.

In at least one embodiment, the mediation system is configured to determine whether the motorist interacting with the Mediation App is in the driver seat of the civilian vehicle, as opposed to being in a passenger seat. For example, during a traffic stop the authority member is interested in verifying that the driver of the civilian vehicle is a properly licensed driver. The mediation system is configured to determine positional information about the motorist using the personal computing device based on image data obtained by a camera on the personal computing device. For example, at the time that the Mediation App prompts the motorist to take a selfie for verifying the identity of the motorist using a first camera on the personal computing device, the mediation system may activate a second camera on the opposite side of the personal computing device. The personal computing device may be controlled to simultaneously capture image data using both cameras. The image data captured by the first camera depicts the motorist's face, and the image data captured by the second camera depicts a portion of the interior of the vehicle on the other side of the personal computing device from the motorist. The image data obtained by the second camera may also depict subject matter that is exterior to the vehicle to assist with determining the location of the individual within the vehicle. The image data may be transmitted remotely for processing.

The “view” from each seat in the vehicle may be unique and should be able to confirm where the person taking the selfie is located in the vehicle. For instance, the view from the driver's seat might include part of the steering wheel, part of the dashboard, and the front left side of the vehicle. One can appreciate that the view from the passenger's side in the front would be different from the driver's side of the vehicle, or any of the seats in a second or third row of the vehicle.

In an embodiment, the image data is transmitted to the remote server for automated processing using image analysis techniques. If the image analysis reveals that the second camera captures a steering wheel in the image data, then the remote server may confirm that the motorist is the driver (or at least is sitting in the driver seat). In an alternative embodiment, the image analysis of the image data depicting the interior of the vehicle may be performed manually by the authority member or by a third party (e.g., an authority member at a remote dispatch location). Alternatively, instead of simultaneous operation of the two cameras, the image data captured by the second camera facing away from the motorist may be captured slightly before or after the selfie image data. The Mediation App controls the acquisition of the image data via the first and second cameras on the personal computing device within the App to prevent a motorist from uploading previously-acquired images or otherwise doctoring the image data.

At 110, interactions between the authority member and the motorist(s) of the civilian vehicle that is pulled over are managed. As established previously, after the authority member is notified that one or more occupants of the vehicle are registered in the registered database of the mediation system, the authority member can establish communication with the motorist(s) via the Mediation App on the authority member's computing device. The authority member uses the Mediation App to discuss with the motorists the reasoning why the civilian vehicle was pulled over. The authority member may also communicate with the motorists using the Mediation App to establish expectations, to request information, to answer questions, and/or to present a warning or a citation. The mediation system may be configured to allow for various forms of interaction between the authority member and the motorists. For example, the mediation system may provide standard (e.g., pre-scripted) text-based questions and responses, open or customizable text-based communications, voice (e.g., talk) communications, video communications (e.g., with audio and video), or the like. The mediation system in an embodiment is configured to record and remotely store all communications between the two parties. Optionally, the mediation system may allow for storing at least some of the communications on one or both of the local devices, such as storing the interaction on the computing device that is in the authority vehicle. In one embodiment, the authority member may initiate a text interaction, and the mediation system transmits a control signal to the personal computing device of the motorist to activate the Mediation App and display a notification text message to the motorist. Conversely, the motorist may initiate the text interaction in a similar fashion.

In one communication option provided by the mediation system, the authority member and the motorist interact through pre-scripted messages to eliminate linguistic characteristics (e.g., errors, slang words, etc.) that may confuse the interaction and may also lead to prejudice. Pre-scripted messages have an advantage that motorist age, race, education, etc. is not indicated by linguistics. Sample messages can include why a motorist was pulled over (e.g., “you were pulled over for speeding”), the speed at which the policeman believes they were traveling (e.g., “recorded as driving 52 MPH in a 35 MPH zone”), a defense of why the motorist was in violation (e.g., “my speedometer is broken,” “my wife is in labor,” etc.) The Mediation App can present a list of possible pre-scripted answers and questions for the authority member and the motorist to select. The Mediation App may also provide both the authority member and the motorist the option to break this paradigm of pre-scripted messages and enter a custom text message if desired.

All communications between the authority member and the motorist may be tracked and recorded for future reference. And, these interactions can also be sent and/or copied to other parties (e.g., parents or relatives of the motorist, a lawyer, police station attendants in a call center, etc.). The determination of who receives these messages can be set up during the registration process, or at a later point by changing settings/preferences on the Mediation App.

It is recognized that some motorists may not speak the same language as the authority member. The Mediation App may have a language option in the settings in which the motorist can select a language for communications. The Mediation App may translate messages received from the authority member, and may translate messages transmitted by the motorist. For example, if the authority member speaks English and generates text messages in English, the mediation system translates the English messages to the language selected by the motorist and displays the message in the motorist's language on the motorist's personal computing device. The messages from the motorist may be translated into English before being displayed on the authority member's computing device. The Mediation App may translate both the pre-scripted text messages and custom text messages.

In an embodiment, all communications between the authority member and the motorist using the authority computing device and the motorist's personal computing device are enabled using the mediation system (e.g., within the Mediation Apps), as opposed to being enabled via default text applications and/or voice applications. The communications are mediated by the remote server. The remote server may withhold certain information from the communicating parties. For example, during the communication period, the remote server may not present to the authority member the name or phone number of the motorist with whom the authority member is communicating.

In addition to text, voice communications can also take place verbally through the devices on either side. The voice communications are enabled using the mediation system (e.g., within the Mediation Apps) such that the communications are relayed through the remote server and are recorded in a database. The mediation system optionally may modulate voices to reduce the possibility that the voices can be recognized as belonging to any subgroup of civilians (e.g., based on race, age, gender, etc.). During the voice communications, the phone numbers of the communicating parties may not be presented to the other party. In addition to discussing the reason for pulling over the vehicle, the authority member may utilize voice communications using the Mediation App to guide the motorist in the acquisition of the requested image data for validating the driving documents and/or remote inspection of the interior of the vehicle prior to the authority member approaching the vehicle, as described herein.

At 112, a warning or a citation may be issued to the motorist by the authority member. For minor traffic violations or vehicle infractions, such as a routine speeding infraction or a broken tail light, the authority member may not need to approach the civilian vehicle at all during the length of the temporary detention. After the appropriate validation and interaction, a ticket can be issued to the motorist through the mediation system (and presented to the motorist via the Mediation App). The ticket may be texted, emailed, and/or mailed to an address on file (e.g., in the registration database or on the driver's license). The mediation system may transmit the ticket to appropriate state and/or federal databases to make sure the ticket is properly recorded in all places. Therefore, the authority member can issue the ticket (or a warning if so desired) without exiting the authority member during the traffic stop. If the authority member does decide to approach the vehicle, the authority member can still issue the ticket via the Mediation App in front of the motorist or upon returning to the patrol vehicle. The Mediation App may prompt to the motorist to acknowledge receipt of the ticket (or warning) before the traffic stop is completed or at a later time.

At 114, if the authority member decides to approach the vehicle, the authority member may utilize the mediation system to set expectations prior to the authority member approaching the civilian vehicle. The authority member may decide to resort to the convention practice of approaching the vehicle at any time in the traffic stop if there is a suspicion or concern. For example, the authority member may approach the vehicle if there is a question about the legitimacy of the vehicle or driver, a concern about the driver or an occupant, or the like. The mediation system is configured to make the approach process less stressful and safer for both the authority member and the occupants of the vehicle.

The authority member can utilize the mediation system to communicate with the motorists prior to approaching the vehicle in order to introduce the authority member and set expectations. The authority member may send text-based communications to the motorists using the mediation system that outline what the authority member will be doing and what is expected of the motorists when the authority member approaches the vehicle. The messages are displayed to the motorists in the Mediation App. The messages may inform the motorists that the authority member will be approaching shortly. One or more of the messages may be instruction messages that indicate tasks requested by the authority member for performance by the motorist(s) while the authority member is within the authority vehicle. For example, the instruction messages may instruct the motorists to stay in the vehicle, to keep hands on laps, and not to reach for anything. The instruction messages may also request additional tasks, such as to place the driver's license of the driver and the vehicle registration on the dashboard. The Mediation App on the personal computing device may prompt the motorist holding the personal computing device to acknowledge all requests so that there is no doubt that the motorist has received and understands the messages. For example, the Mediation App may display an interface button that, when selected by the motorist, transmits response messages to the remote server that acknowledge the instruction messages. The Mediation App may display the instruction messages one-at-a-time, and may display a subsequent instruction message after receiving a response message corresponding to a previous instruction message.

Instead of, or in addition to, the text-based messages, the authority member may choose to initiate a phone call to the motorist via the Mediation App, and the entire communication may be recorded and stored via the remote server. The authority member may request permission for the voice communication via the text function using the Mediation App. A speech or voice-based conversation may be helpful to overcome some limitations of texting.

Prior to approaching the vehicle, the authority member may desire to preview the interior of the vehicle to confirm the number of occupants and whether there are any items or conditions within the vehicle that appear suspicious. Such an inspection may reduce the uncertainty during the physical approach, potentially reducing stress and anxiety. The authority member may utilize the mediation system to request the motorist to capture image data (e.g., photos or a video) of the inside of the vehicle through the Mediation App. If the motorist agrees to comply, the Mediation App may automatically guide the motorist through the process of acquiring the image data, via a user interface text commands and/or audible navigation. For example, the Mediation App may activate the video function of the outward facing camera on the personal computing device, and may instruct the motorist to slowly take a panorama view of the interior of the vehicle. Alternatively, the Mediation App may activate the camera and instruct the motorist to acquire an image or video of the driver seat, then the passenger seat, then the rear seats, etc., in a designated sequence.

The mediation system transmits the image data to the remote server, which may transmit the image data to the authority member in the patrol vehicle. The authority member views the image data and may provide customized guidance to the motorist via the Mediation App via text commands and/or voice commands. The Mediation App could enable the authority member to speak to the motorist during the inspection process, guiding the motorist to show specific parts of the vehicle. For example, the authority member can request the motorist to acquire an image or video showing the area behind the front passenger seat. If the vehicle has many occupants, or looks suspicious to the Authority during this inspection, the authority member has the ability to call for backup (or take other precautions) prior to approaching the vehicle.

Upon approaching the vehicle after the preview inspection, the method 100 proceeds to 112 and the authority member has the option of issuing a warning or a ticket. Because the authority member has approached the vehicle, the authority member interacts with the occupant(s) in a conventional face-to-face encounter. The authority member may utilize the mediation system to issue the warning or ticket, in order to create a record of the interaction.

In summary, the mediation system does not obstruct or interfere with the authority member's ability to approach a stopped vehicle. The authority member can always approach the vehicle, but has the advantage of having first established communication with the motorists to set expectations. In addition, the motorist may have already proved that he or she is a valid driver and that the car is properly registered. Another advantage of the mediation system is that some portions of the transaction may be accomplished while the authority member is within the authority vehicle, which results in a reduced amount of time that the authority member is outside of the authority vehicle and in a compromised (or higher-risk) situation.

In one or more embodiments, the mediation system is configured to function during a temporary detention (e.g., traffic stop) even if the driver of the civilian vehicle that is pulled over is not a registered user that has the Mediation App on their personal computing device. In a first example, a passenger of the vehicle may be a registered user that has the Mediation App. This situation may occur when a mother does not have the Mediation App, but her son in the vehicle does have the Mediation App. In this case, the driver may utilize the personal computing device of the passenger. The authority member initiates contact with the personal computing device of the passenger, as in the process described above. The driver can perform the sequence of verification and validation using the passenger's personal computing device. For example, the driver uses the personal computing device to acquire image data of the driver's own face, driver's license, registration, etc. to verify the driver's identity and validate the driver and vehicle.

In a second example, a situation can exist where the motorist has registered his or her cell phone with one or more vehicles through the Mediation App, but has not registered the particular vehicle that has been pulled over. For example, a registered user may be driving a rental car or a borrowed car that has not been associated with their cell phone number in the registration database of the mediation system. Upon getting pulled over, the motorist can activate or open the Mediation App and select an option on the interface to indicate that the motorist has been pulled over (e.g., clicking a button that says, “I've been pulled over”). The personal computing device may notify the remote server, which then uses location information from the personal computing device (e.g., GPS or cell signals) to search for authority vehicles proximate to the personal computing device. Upon detecting an authority vehicle within a designated proximity of the personal computing device that contacted the remote server, the remote server transmits a notification message to the authority member in that authority vehicle. In this manner, the motorist can proactively initiate the communication with the authority member using the Mediation App, even in an unregistered vehicle. Alternatively, after being pulled over, the motorist can open the Mediation App and enter a vehicle identifier (e.g., license plate number) of the vehicle they are within. This identifier is then relayed to the remote server, and the Authority is alerted to the fact that the unregistered vehicle has registered users inside. The remainder of the process takes place as previously described.

In a third example, none of the occupants of the stopped vehicle is registered with the mediation system or has the Mediation App. One option for utilizing the mediation system is for the driver (or passenger) to download the Mediation App on the spot. The Mediation App may query the user as to whether they have just been pulled over. If the user responds in the affirmative, the Mediation App can immediately transmit a signal to the remote server, and the remote server may utilize location data to compare the location of the user's computing device to the location of a proximate authority vehicle (e.g., via GPS, cell phone signal triangulation, etc.). Subsequent interaction would take place using the occupant's personal computing device as previously described.

Another option instead of downloading the Mediation App is for an occupant to text or call a dedicated number that is owned or registered to the mediation system, server, service, or the like. The designated number may be a phone number, such as “611” or “888-555-1313”. Upon calling the designated number, the personal computing device may interact and communicate with the remote server (or a device thereof) or a person affiliated with the mediation service. This method could use existing text and phone capabilities with no software download. In this embodiment, texts would be directed to this dedicated number, which would connect to the remote server. The remote server, in turn, can identify the authority vehicle that has pulled over the vehicle using standard location methods (GPS, cell phone triangulation . . . etc.).

Alternatively, the user may be able to complete at least some of the registration process using the designated number without downloading the Mediation App. For example, the motorist may contact the designated phone number and, when prompted, enter the license plate number of the vehicle they are driving. Another option is for the motorist to access a website which provides the same basic functionality as the Mediation App, but it is online instead of downloading the Mediation App. For example, after a motorist is pulled over in a traffic stop, the motorist can access a designated website and associate their cell phone number with the car they are driving. Regardless of whether the information is obtained via a designated phone number or a website, the information is uploaded to the registration database. If the information is added quickly enough, the authority member that pulled over the vehicle can proceed as though the information was added in a regular pre-registration process and proceed as previously described. If there is a delay in adding the information, the authority member may receive a negative response when inquiring the mediation system as to whether there is a registered user associated with the vehicle. However, as soon as the remote server receives a new registration connecting a cell phone with the license plate about which the authority member has recently inquired, the remote server will send a notification to the authority member that there is a registered user for the vehicle in question.

The remote server can transmit texts to the authority member, and track and facilitate subsequent interaction between the authority member and the motorist. This same process could also make a voice connection between the authority member and the motorist and/or implement other features described in this process. For instance, the validation processes could take place remotely via text, and photos (drivers licenses, registrations, selfies . . . etc.) can all be sent to the remote server for analysis. The authority member can then be notified of the results, even though the motorist is not using the Mediation App. In an alternative embodiment, a direct text connection or voice-based call can be made between the authority member and the motorist, but is less preferred than using the mediation system due to features on the mediation system that provide anonymity and record the communications, which are not available through direct text and voice communications.

In one or more embodiments, a motorist that is pulled over by an authority vehicle may initiate the mediation system by utilizing the motorist's personal computing device to transmit an initiation signal (e.g., initial request signal) to the remote server. As described above, the initiation signal may be transmitted via the motorist dialing or texting a dedicated number, opening the Mediation App, downloading the Mediation App, accessing a dedicated website, or the like. Upon receiving the initiation signal from the personal computing device of the motorist, the remote server determines the location of the personal computing device. For example, the remote server may receive (automatically or upon request) location data (e.g., GPS coordinates or the like) from the personal computing device. Then, the remote server identifies the authority vehicle that has stopped the motorist by detecting which authority vehicles are proximate to the civilian vehicle. In one embodiment, the remote server may access a database that includes information about locations of various authority vehicles in a group, such as a department, as well as identifying information about the authority vehicles. The database may receive real-time updated location data from the authority vehicles within the group. The remote server may compare the locations of the authority vehicles in the database to the location of the personal computing device to detect which authority vehicle is involved in the traffic stop.

Upon detecting and identifying the authority vehicle involved in the traffic stop, the remote server generates an activation request signal for transmission to that specific authority vehicle, or at least to an authority computing device associated with that vehicle. For example, the activation request signal may be transmitted to a laptop within the authority vehicle, an integrated information system built into the authority vehicle, a mobile device held by an authority member assigned to that authority vehicle, or the like. The activation request signal may open the Mediation App on the authority computing device (e.g., the laptop, mobile device, etc.), and prompt the authority member to participate in communicating with the motorist via the Mediation App. In response to receiving an acceptance signal from the authority computing device, the mediation system enables wireless communications of information between the authority computing device and the personal computing device, according to the procedures described herein.

FIG. 2 is a block diagram illustrating a mediation system 116 formed in accordance with embodiments herein. The mediation system 116 includes client computing devices 118 that are capable of communicating over a network 120 with the remote server 130 of the mediation system 116. The client computing devices 118 include both the personal computing devices 152 of the civilian motorists and the authority computing devices 154 of the authority members. In at least one embodiment, the personal computing devices 152 and the authority computing devices 154 indirectly communicate with each other via the network 120 and the remote server 130.

The remote server 130 may include one or more application servers and, optionally, one or more web servers. The remote server 130 hosts the mobile application associated with the mediation system 116 (e.g., the Mediation App) and has the tools, application program interfaces (APIs), and scripts, among other things, that may be used for the Mediation App. In some embodiments, the Mediation App includes one or more user interfaces and/or pages that allow a user to view and respond to communications regarding a traffic stop or other temporary detention. The remote server 130 may represent only a single server or a plurality of different servers that communicate with one another and the client computing devices 118 over the network 112. The remote server 130, in some embodiments, is configured to receive and interpret requests through the network 120 from the personal computing devices 152 and the authority computing devices 154 (or, more specifically, from software applications 146 thereof). The remote server 130 is also configured to respond to the requests and transmit data via electrical signals to the client computing devices 118 in a predetermined format (e.g., HTML format). In some cases, the remote server 130 and the client computing devices 118 may form a cloud-type computing system (e.g., public cloud, private cloud, or hybrid cloud).

The network 120 represents any one or combination of multiple different types of networks, such as cable networks, the Internet, private intranets, local area networks, wide area networks, wireless networks, or the like. In particular embodiments, the network 120 is a wireless network that spans miles, allowing the remote server 130 to be located miles away from the vehicles during a traffic stop while still able to communicate with the computing devices 118 in the vehicles.

The client computing devices 118 may be implemented as various types of computing devices. These devices may include, for instance, smart phones, personal computers (PCs), tablet computers, notebook computers, laptop computers, electronic book readers, personal data assistant (PDA) devices, video game consoles, and so forth. In particular embodiments, the personal computing devices 152 may include portable or handheld devices, such as smart phones or tablet computers. A portable or handheld device is relatively lightweight (e.g., less than six pounds) such that an average adult individual may hold and re-orient the device during the course of its intended operation. In the illustrated embodiment, the computing device is a smart phone 160. Data displayed on the portable devices may include, among other things, images, video, text-based messages, or the like. In particular embodiments, the authority computing devices 154 may include laptop computers, notebook computers, or tablet computers that are mounted within the authority vehicle, such as a computer mounted to the console of a patrol vehicle.

The client computing devices 118 (including both the personal and authority computing devices 152, 154) are configured to operate application programs, such as the Mediation App 146 described herein. Optionally, the Mediation App 146 may be configured to work with sub-applications 148 or scripts (e.g., plug-ins or extensions) that are executed from within the application program or in concert with the application program. The sub-application 148 runs or is executed concurrently with the application program 146. Optionally, the sub-application 148 may be stored within the client computing devices 118 and/or the remote server 130. For example, the sub-application 148 may be stored within the authority computing devices 154 or within another storage device onboard the authority vehicle.

The Mediation App 146 may be or include third-party software that retrieves, presents, and communicates information through the network 120. The Mediation App 146 on the computing devices 118 communicates with the remote server 130 over the network 120. The Mediation App 146 may communicate using, for example, a known protocol (e.g., Hypertext Transfer Protocol (HTTP) or HTTP-secure (HTTPS)). More specifically, the Mediation App 146 may send requests (e.g., HTTP requests) for information to any web-accessible internet address. The Mediation App 146 may also display the information on the respective client computing device 118 in accordance with a predetermined format (e.g., HTML format). The sub-applications 148 may be launched from within the Mediation App 146 and, optionally, communicate with the remote server 130 to retrieve information that may be displayed to the user through the Mediation App 146. Embodiments set forth herein may be implemented, at least in part, using the Mediation App 146, a sub-application 148 associated with the Mediation App 146, or other software program having computer executable code.

The remote server 130 includes one or more processors 140 that are operatively connected to data stores 134, 136. The data stores 134, 136 are computer-readable storage media (e.g., memory devices). The data store 134 includes the registration database 150. One or both of the data stores 134, 136 may store additional information, such as program instructions (e.g., software) that direct the processors 140 to carry out the operations of the methods described herein. For example, the data stores 134, 136 may store program instructions that are used by the processors 140 to look up in the registration database 150 for registered users upon receiving a vehicle identifier, for detecting whether any of the registered users are within the vehicle based on a proximity of the personal computing devices of the users to the authority vehicle involved in the traffic stop, and for performing other operations of the methods described herein. The data stores 134, 136 may also record and store the communications of interactions between the authorities and civilians during traffic stops. For example, the data stores 134, 136 may save copies of text messages communicated between the two parties, voice recordings, video recordings, issued tickets, image data acquired, or the like. The data stores 134, 136 may also store information about how to display content to a user, either a civilian or an authority member.

Also shown in FIG. 2, the smart phone 160 includes a user display 122, which may be a touchscreen in some embodiments that is configured to identify and locate a touch from a user's finger or stylus. The user display 122 is framed by a housing 125 of the smart phone 160. The user display 122 defines an area that may present virtual user-selectable elements 123 that may be selected by the user on the user display 122. Alternatively or in addition to the user-selectable elements 123, a user may select tangible or physical user-selectable elements 124 (e.g., buttons, switches, or the like). The smart phone 160 also includes a first camera 162 along the same side of the housing 125 as the user display 122. The motorist using the smart phone 160 may be prompted by the Mediation App 146 to take a selfie using the first camera 162, such that the motorist can view the motorist's face on the display 122 prior to capturing the image data.

Also shown in FIG. 2, the smart phone 160 may include one or more processors 126 and computer-readable storage media 127. The computer-readable storage media 127 may store program instructions or computer code for a display application, such as the Mediation App 146. The Mediation App 146 is configured to display various graphical user interfaces, images, or the like on the user display 122 to present information to the user and prompt the user for responses. In some embodiments, the computer-readable storage media 127 may store program instructions or computer code for a sub-application 148. Optionally, the sub-application 148 may be a plug-in or extension that is executable within or by the Mediation App 146.

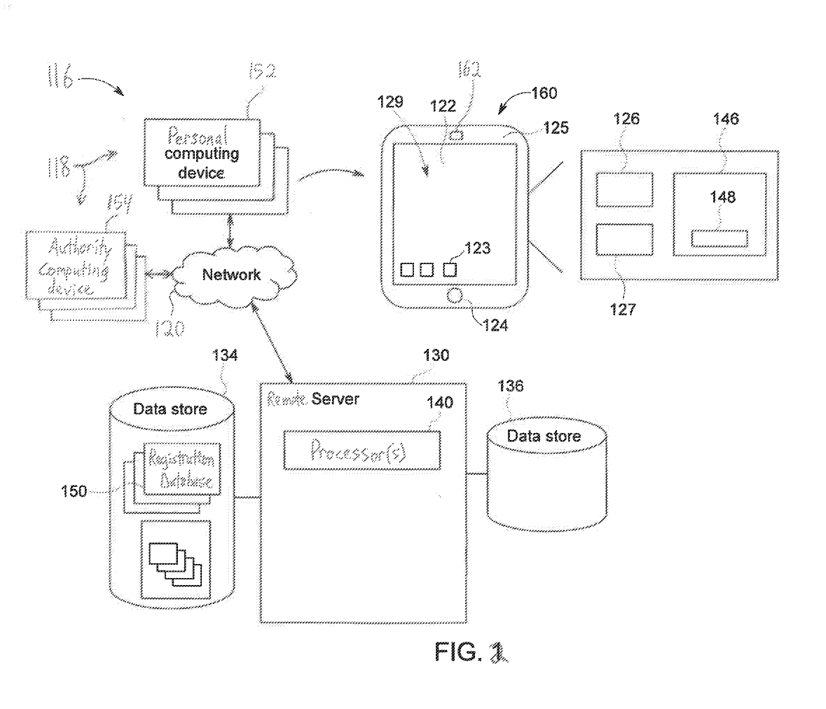

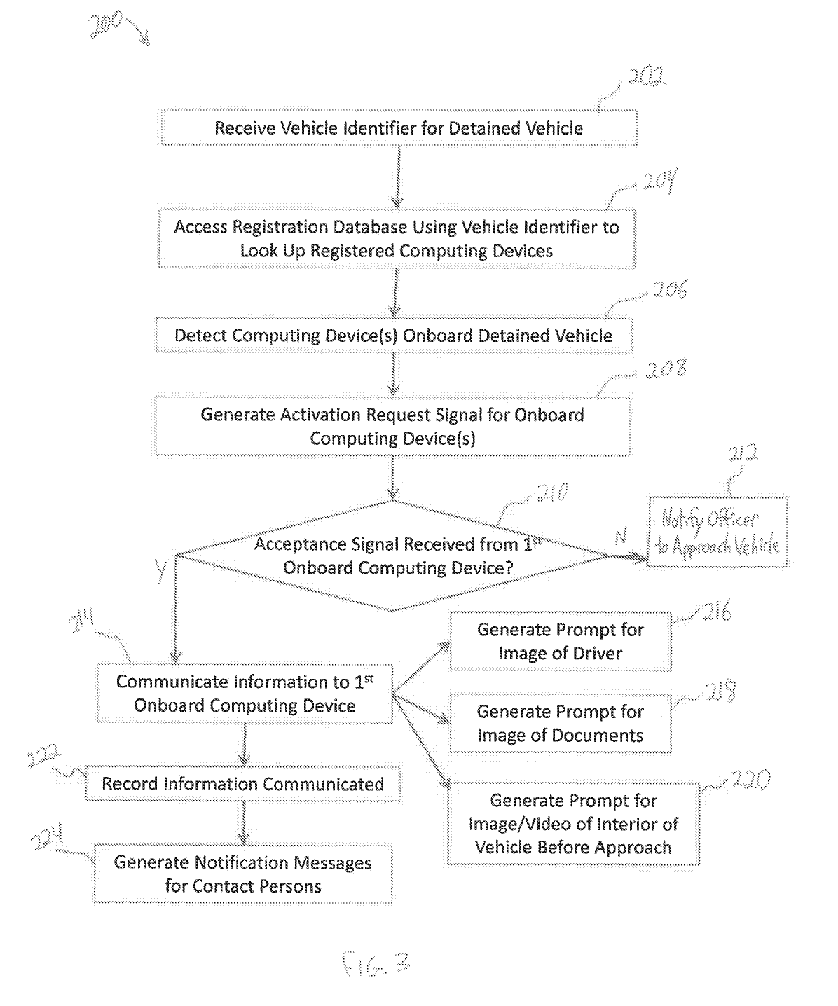

FIG. 3 is a flow chart of a method 200 for managing the interactions between civilian motorists and authorities during a traffic stop according to an embodiment. The method 200, or at least portions thereof, may be performed via the one or more processors 140 of the remote server 130 of the mediation system 116 shown in FIG. 2. Several portions of the method 200 may overlap with the method 100 of FIG. 1. At 202, a vehicle identifier is received that corresponds to a detained vehicle. For example, the vehicle is detained during a traffic stop by an authority, such as a law enforcement officer. The vehicle identifier is uniquely associated with the specific vehicle, and may include a license plate, a VIN number, or the like. The vehicle identifier may be received via a wireless message transmitted by a computing device 154 within the officer's (e.g., authority) vehicle or by a motorist (e.g., driver or passenger) within the civilian vehicle that is detained.

At 204, a registration database 150 is accessed to determine one or more personal computing devices 152 that are registered in the database 150 as associated with the vehicle that is detained. For example, the one or more processors 140 may access the registration database 150 to look up registered personal computing devices 152 based on the vehicle identifier received. The personal computing devices 152 may be smart phones 160 or the like. If there are no registered personal computing devices associated with the detained vehicle in the database 150, the one or more processors 140 may notify the officer of this fact, and the officer may approach the vehicle according to conventional traffic stop procedure. On the other hand, if there is at least one personal computing device 152 registered with the vehicle, the method 200 proceeds to step 206.

At 206, the registered personal computing devices 152 that are onboard the detained vehicle are detected based on a proximity of the personal computing devices 152 to the location of the patrol vehicle (e.g., authority vehicle) that pulled over the civilian vehicle. In one embodiment, location-based services are utilized to detect the proximity of the registered personal computing devices 152 to the patrol vehicle. For example, the one or more processors 140 of the remote server 130 may generate location request signals that are transmitted to the registered personal computing devices 152 and to a computing device 154 in the patrol vehicle. The location request signals ask the recipient devices 152, 154 to provide GPS coordinates (or other location data) of the devices to the remote server 130. The remote server 130 is configured to compare the received location data of the personal computing devices 152 to the location data of the patrol vehicle, and the personal computing devices 152 within a designated proximity of the patrol vehicle are detected as being onboard the detained vehicle. In another embodiment, the proximity of the personal computing devices 152 to the patrol vehicle is determined via other means such as triangulation using cell towers, connecting to one or more of the computing devices 152 via Bluetooth or by establishing a local network, or the like. For example, if a personal computing device 152 is able to connect to a local network hotspot generated by the patrol vehicle with a limited range, then that personal computing device 152 is within the designated proximity of the patrol vehicle. The designated proximity may be user specified or technology specified, and may be a distance of 5 m, 10 m, 25 m, 50 m, or the like.

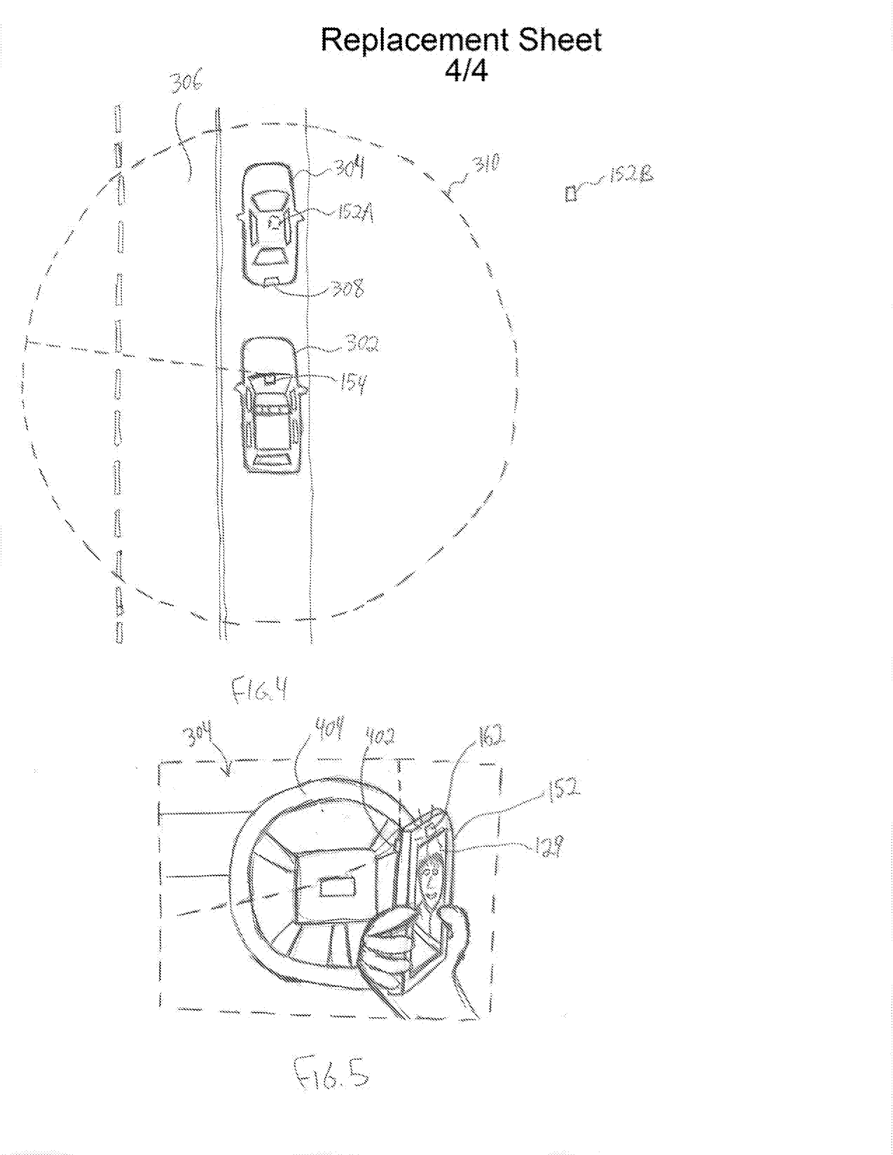

FIG. 4 is a top down illustration of a traffic stop in which a patrol vehicle (e.g., an authority vehicle 302) has pulled over a civilian vehicle 304 on the side of a road 306. In an embodiment, the officer in the patrol vehicle 302 inputs the number of the license plate 308 into the authority computing device 154, which transmits the number as the vehicle identifier to the remote server 130 (FIG. 2). The remote server 130 determines that there are two personal computing devices 152A, 152B associated with the civilian vehicle 304. The remote server 130 contacts both of the computing devices 152A, 152B and receives location data from each. The remote server 130 also receives location data from the patrol vehicle 302. As shown in FIG. 4, only a first computing device 152A is within the designated proximity 310 of the patrol vehicle 302. The second computing device 152B is outside of the designated proximity 310. As a result, the remote server 130 detects that the registered user associated with the first computing device 152A is onboard the detained vehicle 304, and the registered user associated with the second computing device 152B is not onboard the detained vehicle 304.

Referring now back to FIG. 3, at 208, an activation request signal is generated for transmission to the one or more computing devices 152 that are onboard the detained vehicle. Upon receipt of the activation request signal, the recipient computing device may open the Mediation App and display a notification that prompts a user to respond to the activation request. The user may select a virtual or physical button to confirm that the user would like to communicate using the mediation system. Upon receiving such a selection, the computing device 152 transmits an acceptance signal to the remote server 130.

At 210, it is determined whether an acceptance signal has been received from a first personal computing device onboard the detained vehicle. If so, then the method 200 proceeds to 214 and information is communicated to the first personal computing device to discuss and carry out the business of the traffic stop, as described herein. For example, acceptance of the activation request signal may establish a communication link between the remote server 130 and the first computing device 152. The communication link may include a specific protocol or rules for subsequent communications between the server and the computing device. If no acceptance signal is received, the method 200 proceeds to 212 and the officer is notified to proceed with a conventional traffic stop procedure that includes a face-to-face interaction. The lack of an acceptance signal may indicate that the motorist does not want to communicate using the mediation system.

After establishing the communication link, various information may be transmitted to the computing device 152 onboard the detained vehicle, and various information may be transmitted from the computing device 152 to the remote server 130. For example, in order to verify the identity of the driver of the vehicle, at 216 the remote server 130 may generate a prompt for acquiring a contemporaneous image of the driver in the vehicle. The prompt may be a control signal that is transmitted to the first computing device 152. The control signal, when received at the computing device, may open or activate a first camera 162 on the device, and may display a text message that instructs the user to take an image of the user's face for verification purposes.

FIG. 5 illustrates a personal computing device 152 onboard a detained vehicle 304 according to an embodiment. The personal computing device 152 is held by a user. In an embodiment, the control signal that prompts the acquisition of the driver image also activates a second camera 402 on the personal computing device 152 that is on an opposite side as the first camera 162. The display 129 shows the field of view of the first camera 162, which features the face of the user. Upon the user selecting the button to capture the image data, both cameras 162, 402 may acquire image data at the same time (or at different times within a narrow time period of less than 1 second, for example). As the first camera 162 points towards the user's face, the field of view of the second camera 402 can image a portion of the interior of the vehicle 304 on the other side of the computing device 152. In the illustrated embodiment, the image data captured by the second camera 402 shows a steering wheel 404 of the vehicle 304. The image data captured by both of the cameras 162, 402 is transmitted to the remote server 130 for analysis. The subject matter depicted in the image data acquired by the second camera 402 may be used to determine the location or position of the user within the vehicle 304. For example, because the steering wheel 404 appears prominently in the image data, the processors analyzing the image data may determine that the user that is the subject of the image taken by the first camera 162 is in the driver seat. The image of the user acquired by the first camera 162 may be analyzed and compared to a reference image of the user, such as a driver's license photo, to verify the identity of the user.

Referring now back to FIG. 3, the remote server 130 may also generate prompts to request the user to acquire image data depicting various documents at 218. The documents may include a driver's license, registration, inspection sticker, etc. Upon receiving the image data, the remote server 130 may analyze the images to extract information that is used to validate the documents. For example, the remote server 130 may compare the extracted information to information in a database to validate the documents.

At 220, if the officer desires to inspect the interior of the detained vehicle, the remote server 130 may generate a prompt that is sent to the personal computing device 152 to acquire images or video of the interior of the vehicle. The acquisition of the images and/or video may be guided by instructions provided by the mediation system or the officer from within the patrol vehicle, utilizing the Mediation App.

At 222, all of the communications and interactions between the officer and the user onboard the detained vehicle may be stored by the remote server 130 within a memory or storage medium. The information can be accessed at a later time to reduce speculation about what occurred during the interaction. The information that is stored may include text messages, voice recordings, images, video, or the like.

At 224, the remote server 130 may generate notification messages to alert and inform contact persons that are not within the detained vehicle about the traffic stop. The contact information of the contact persons may be stored in the registration database and accessed via the remote server 130. Optionally, the remote server 130 may designate as contact persons and persons affiliated with registered personal computing devices that are determined to be remote from the detained vehicle. For example, referring back to FIG. 4, the remote server 130 may designate the user affiliated with the second computing device 152B as a contact person because the second computing device 152B is outside of the proximity 310 of the patrol vehicle 302. The notification messages may inform the users about the traffic stop. Optionally, the notification messages may provide copies of the information that is shared between the officer and the occupant in the detained vehicle during the traffic stop.

As used herein, relative or spatial terms such as “top,” “bottom,” “left,” “right,” “front”, “rear”, “upper,” and “lower” are only used to identify and distinguish the referenced elements and do not necessarily require particular positions or orientations in the surrounding environment of the tank support assembly 108. The relative or spatial terms are specific to the orientations depicted in the figures.

As described herein, the mediation system and method may remove or mitigate bias against minorities or other subgroups of civilians during temporary detentions, such as traffic stops. The mediation system and method may also increase safety of law enforcement officers during traffic stops by allowing the officers to remain in their vehicles for a greater percentage of the traffic stop, or for the entire duration of the traffic stop. The mediation system and method allows for communications between the parties prior to any face-to-face engagement and the communications may reduce apprehension and stress by setting expectations and enabling the office to view an interior of the civilian vehicle prior to approaching. The mediation system and method may track and/or record the communications and interactions between the parties, which can be accessed during a dispute to potentially reduce liability and the number lawsuits filed against law enforcement agencies.

As mentioned previously, this basic concept can also be applied to buildings, such as residences, as well as vehicles. A person can register their phone with a particular house, apartment, condo . . . etc. and law enforcement officers can establish communication with the resident(s) before ever approaching the building.

In certain situations, a civilian may want to validate that they have been pulled over by a legitimate authority (and not an imposter). The same system can be configured to deliver a message to a user that they have been pulled over by a legitimate authority.

Finally, this system can be implemented with more than two parties, when multiple parties need to interact with one another.

As used herein, the terms “computer” or “computing system” may include any processor-based or microprocessor-based system including systems using microcontrollers, reduced instruction set computers (RISC), application specific integrated circuits (ASICs), logic circuits, and any other circuit or processor capable of executing the functions described herein. The above examples are exemplary only, and are thus not intended to limit in any way the definition and/or meaning of the term “computer” or “computing system.”

The computer or processor executes a set of instructions that are stored in one or more storage elements, in order to process input data. The storage elements may also store data or other information as desired or needed. The storage element may be in the form of an information source or a physical memory element within a processing machine.

The set of instructions may include various commands that instruct the computer or processor as a processing machine to perform specific operations such as the methods and processes described herein. The set of instructions may be in the form of a software program. The software may be in various forms such as system software or application software. Further, the software may be in the form of a collection of separate programs, a program module within a larger program or a portion of a program module. The software also may include modular programming in the form of object-oriented programming. The processing of input data by the processing machine may be in response to user commands, or in response to results of previous processing, or in response to a request made by another processing machine.

As used herein, the terms “software” and “firmware” are interchangeable, and include any computer program stored in memory for execution by a computer, including RAM memory, ROM memory, EPROM memory, EEPROM memory, and non-volatile RAM (NVRAM) memory. The above memory types are exemplary only, and are thus not limiting as to the types of memory usable for storage of a computer program

As used herein, a structure, limitation, or element that is “configured to” perform a task or operation is particularly structurally formed, constructed, or adapted in a manner corresponding to the task or operation. For purposes of clarity and the avoidance of doubt, an object that is merely capable of being modified to perform the task or operation is not “configured to” perform the task or operation as used herein.

It is to be understood that the above description is intended to be illustrative, and not restrictive. For example, the above-described examples (and/or aspects thereof) may be used in combination with each other. In addition, many modifications may be made to adapt a particular situation or material to the teachings of the various examples of the disclosure without departing from their scope. While the dimensions and types of materials described herein are intended to define the parameters of the various embodiments of the disclosure, the embodiments are by no means limiting and are example embodiments. Many other examples will be apparent to those of ordinary skill in the art upon reviewing the above description. The scope of the various embodiments of the disclosure should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

This written description uses examples to disclose the various embodiments of the disclosure, including the best mode, and also to enable any person skilled in the art to practice the various embodiments of the disclosure, including making and using any devices or systems and performing any incorporated methods. The patentable scope of the various embodiments of the disclosure is defined by the claims, and may include other examples that occur to those skilled in the art. Such other examples are intended to be within the scope of the claims if the examples have structural elements that do not differ from the literal language of the claims, or if the examples include equivalent structural elements with insubstantial differences from the literal language of the claims.

What is claimed is:

1. A method comprising:
receiving, at one or more processors, an identifier that is uniquely associated with a civilian vehicle;
accessing a registration database to determine one or more personal computing devices that are registered with the identifier;
detecting that at least one of the one or more personal computing devices is located onboard the civilian vehicle;
generating an activation request signal for transmission to the at least one personal computing device onboard the civilian vehicle; and
responsive to receiving an acceptance signal from a first personal computing device of the at least one personal computing device onboard the civilian vehicle, wirelessly communicating information to said first personal computing device.

2. The method of claim 1, wherein the wirelessly communicating information includes communicating information about a traffic stop to the first personal computing device as requested by an authority member within an authority vehicle that stopped the civilian vehicle during the traffic stop.

3. The method of claim 1, wherein the identifier is one or more of a license plate number or a vehicle identification number, and the one or more processors receive the vehicle identifier from an authority computing device located proximate to the civilian vehicle.

4. The method of claim 1, wherein the one or more processors are remotely located relative to the civilian vehicle.

5. The method of claim 1, wherein the at least one personal computing device is detected to be onboard the civilian vehicle by comparing global positioning system coordinates received from the at least one personal computing device and from an authority computing device associated with a an authority vehicle and determining, via the global positioning system coordinates, the at least one personal computing device to be within a designated proximity of the authority computing device.

6. The method of claim 1, wherein the at least one personal computing device is detected to be onboard the civilian vehicle by determining one or more of current speed, historical speed, current direction or historical direction of movement of the at least one personal computing device based on location data received from the at least one personal computing device.

7. The method of claim 1, further comprising storing the information that is wirelessly communicated to the first personal computing device and information received from the first personal computing device in a data storage medium that is remote from the first personal computing device.

8. The method of claim 1, wherein the one or more processors are configured to enable an authority computing device to indirectly communicate with the first personal computing device via wireless messages generated by the one or more processors.

9. The method of claim 8, wherein the one or more processors are configured to withhold personal information about a user of the first personal computing device in the wireless messages that are generated for transmission to the authority computing device.

10. The method of claim 1, further comprising transmitting a control signal to the first personal computing device to activate a camera of the first personal computing device and prompt a user of the first personal computing device to acquire image data depicting the user responsive to receiving the control signal.

11. The method of claim 10, further comprising receiving the image data that depicts the user and performing image analysis to compare the image data to a reference image of a known person to positively identify the user as the known person.

12. The method of claim 10, wherein the camera of the first personal computing device is a first camera and the control signal is also configured to activate a second camera of the first personal computing device that faces in an opposite direction as the first camera such that the first and second cameras contemporaneously acquire image data, wherein the image data depicting the user is acquired by the first camera.

13. The method of claim 12, further comprising receiving the image data acquired by the first and second cameras and performing image analysis on the image data that is acquired by the second camera to determine a location of the user of the first personal computing device within the civilian vehicle.

14. The method of claim 1, further comprising determining that a second personal computing device of the one or more personal computing devices registered with the identifier is not onboard the civilian vehicle, and transmitting a notification message to the second personal computing device to notify a user of the second personal computing device that a user of the first personal computing device is temporarily detained by an authority member.

15. The method of claim 1, further comprising transmitting a control signal to the first personal computing device to activate a camera of the first personal computing device and prompt a user of the first personal computing device to acquire image data depicting one or more of a driver's license of the user or a vehicle registration document for the civilian vehicle, and, responsive to receiving the image data, performing image analysis to extract textual information from the one or more of the driver's license or the vehicle registration document.

16. A system comprising:
one or more processors; and
one or more data storage media operatively connected to the one or more processors, the one or more data storage media storing a registration database and program instructions accessible by the one or more processors, wherein, responsive to execution of the program instructions, the one or more processors are configured to:
access the registration database responsive to receiving an identifier that is uniquely associated with a civilian vehicle to determine one or more personal computing devices that are registered with the identifier;
detect that at least one of the one or more personal computing devices is located proximate to an authority vehicle;
generate an activation request signal for transmission to the at least one personal computing device proximate to the authority vehicle; and
responsive to receiving an acceptance signal from a first personal computing device of the at least one personal computing device proximate to the authority vehicle, wirelessly communicate with said first personal computing device.

17. The system of claim 16, wherein the one or more processors are remotely located relative to the authority vehicle.

18. The system of claim 16, wherein the one or more processors are configured to detect the at least one personal computing device to be proximate to the authority vehicle by comparing global positioning system coordinates received from the at least one personal computing device and from an authority computing device associated with the authority vehicle, and determining, via the global positioning system coordinates, the at least one personal computing device to be within a designated proximity of the authority computing device.

19. The system of claim 16, wherein the one or more processors are configured to detect the at least one personal computing device to be proximate to the authority vehicle by determining one or more of current speed, historical speed, current direction or historical direction of movement of the at least one personal computing device based on location data received from the at least one personal computing device.

20. The system of claim 16, wherein the one or more processors are configured to store information that is one or more of wirelessly communicated to the first personal computing device or received from the first personal computing device in the one or more data storage media.

21. The system of claim 16, wherein the one or more processors are configured to enable an authority computing device associated with the authority vehicle to indirectly communicate with the first personal computing device via wireless messages generated by the one or more processors.

22. The system of claim 16, wherein the one or more processors are configured to enable one or more of audio-based communications or video-based communications between the first personal computing device and an authority computing device associated with the authority vehicle.

23. The system of claim 16, wherein the one or more processors are configured to wirelessly communicate with said first personal computing device by transmitting instruction messages to the first personal computing device that indicate tasks requested by an authority member in the authority vehicle and receiving response messages from the first personal computing device that acknowledge the instruction messages.

24. A non-transitory computer-readable storage medium having computer executable code to:
access a registration database in response to receiving a vehicle identifier that is uniquely associated with a civilian vehicle, the registration database accessed to determine one or more personal computing devices that are registered with the civilian vehicle in the registration database based on the vehicle identifier;
detect that at least one of the one or more personal computing devices is located onboard the civilian vehicle based on a proximity of the at least one personal computing device to a location of an authority vehicle that is proximate to the civilian vehicle;
generate an activation request signal for transmission to the at least one personal computing device onboard the civilian vehicle; and
responsive to receiving an acceptance signal from a first personal computing device of the at least one personal computing device onboard the civilian vehicle, wirelessly communicate information to said first personal computing device.

25. A method comprising:
receiving, at one or more processors, an initiation signal from a first personal computing device;
determining a location of the first personal computing device;
detecting an authority member that is proximate to the first personal computing device based on the location of the first personal computing device;
generating an activation request signal for transmission to an authority computing device associated with the authority member; and
responsive to receiving an acceptance signal from the authority computing device, wirelessly communicating information between said authority computing device and said first personal computing device.

26. The method of claim 25, wherein the authority member that is proximate to the first personal computing device is detected by accessing a database that tracks the locations of multiple authority vehicles based on location data received from the authority vehicles.

27. The method of claim 25, wherein the wireless communication of the information between the authority computing device and the first personal computing device is enabled by one or more processors located remote from both the authority computing device and the first personal computing device, the one or more processors generating wireless messages for transmission to the first personal computing device based on wireless messages received from the authority computing device.
